(19) United States
(12) Patent Application Publication
(10) Pub. No.: US 2014/0058963 A1
(43) Pub. Date: Feb. 27, 2014

(54) FACILITY CONTROL SYSTEM (FCS-C2) (INTRODUCTION OF TRAVELER FORM) TO MANAGE ASSETS PLANNING, DESIGN, CONSTRUCTION, FABRICATION, OPERATING, MAINTENCE AND PRODUCTS FABRICATION

(71) Applicants: David Frederick Martinez, (US); Elias George EL-Dahdah, (US); Chuang-Tsair Shih, (US)

(72) Inventors: David Frederick Martinez, (US); Elias George EL-Dahdah, (US); Chuang-Tsair Shih, (US)

(21) Appl. No.: 13/594,290

(22) Filed: Aug. 24, 2012

(51) Int. Cl. G06Q 30/00

(52) U.S. Cl. CPC G06Q 30/018
USPC 705/317

(57) ABSTRACT

A facility control system includes lab, field and construction equipment with a wireless transceiver to transmit machine generated actual initial measurement (AIM) data including GPS information from a field activity to a wide area network; a mobile computer with a wireless transceiver to transmit human generated data from an office, a remote lab, or a field test to the network; and a server coupled to the network, the server including a database to receive machine and human generated AIM data, wherein the server applies statistics and engineering methods to predict specification compliance and performance, wherein the AIM data is used with pre-formatted engineered designed data sheets, including checklist/traveler form, that reflect the exact location of the event and required standards including incorporating best construction practices for installation of construction items and materials quality to promote standardization, uniformity that insures contract compliance and minimizes non-conforming items in real time.

### BACKGROUND

Historically owners/agencies and parts of the management team have been responsible for managing large capital programs from the conceptual, planning, design, construction, operation and maintenance. These programs include horizontal and vertical facilities located on-shore and off-shore, ranging from roads, bridges, water lines, sewer lines, overlays, and sidewalks to variety of building including energy related facilities, fabrication of equipment for use in a facility and office buildings. Program managers were unable to determine the “true” real time status of each facility within their life cycles and each component in the capital improvement program (CIP). Project managers have relied on untimely, invalidated and incorrect information to manage engineering and construction programs. The use of incomplete and inaccurate static data sheets and information that is dated has been the norm in managing projects for the last 200 years. A long term need was to secure real time accurate validated and formatted in best practices review reports information from the entire program management and various construction teams, including field personnel that can assist in the daily decisions that are needed to control the work, cost, schedule and quality as well administrative reporting requirements for each component of the CIP.

### SUMMARY

A facility control system includes lab and field equipment with a wireless transceiver to transmit machine generated actual initial measurement (AIM) data from a field activities, inspection and tests to a computer network, wherein the AIM data is accessible through a geographical information system (GIS); a mobile computer with a wireless transceiver to transmit human generated data from an office, remote construction site, a remote lab, or an inspection or field test to the computer network, wherein the mobile computer logging the AIM data with GPS for 3D identification; a server coupled to the network, the server including a central database to receive machine and human generated AIM data, wherein the server applies statistics and engineering methods to predict specification compliance and performance, wherein the AIM and AFM data is used with pre-formatted engineered designed data sheets and dynamic reporting that reflect the required standards and best practices including incorporating best construction practices for installation of one or more construction items and materials quality to promote standardization, uniformity that insures contract compliance and minimizes non-conforming items, wherein the AIM and AFM data is calculated on the server over the network in real time, wherein the server, lab equipment, and mobile computer form a systematic approach to provide real time dynamic reports regarding one or more components of a capital improvement program (CIP); wherein the systematic approach enables one or more construction teams to generate dynamic reports in real time with best practice engineered designed data sheets for installation and testing of project activities and construction items, and wherein the systematic approach supports indexing of complete project specific data to facilitate document retrieval, project collaboration and the roll-up of the various projects in a program and or a portfolio.

Implementations of the aspect can include one or more of the following. The final data is calculated on the server and shared with project team members over the network. The server stores data in the central database for monitoring multiple projects or programs, regardless of their stage in the life cycle. The server stores data relating to planning, design, construction, operation, maintenance, inspection, testing laboratories and various processes and manufactured construction materials real time on the project cost, schedule, and quality assurance. The status of a given project activity quality can be determined in real time and be shared among all project team members.

In another aspect, an integrated project management module can be connected to a centralized database that includes:

a document control system;

an accounting system;

a scheduling system; and

a geographical information system (GIS).

In other implementations, the system can include a planning module, a design module, a construction module, a maintenance module, and an operations module. The system includes an audit module, an estimating/scheduling module, an inspection module, and a testing module. The database captures actual final measurement (AFM). The statistics and engineering methods comprise aggregate, asphalt, concrete and soil tests and all types of construction materials. A plurality of pre-formatted forms can be stored in the mobile computer. A field engineering form can capture a cost, a schedule, labor, equipment and a quantity. An inspector form can capture a work activity, a daily report and a “checklist” designed with consideration of required standards, indexing logs and consideration of best practices installation report. A tester form can capture laboratory and field test data. The system can receive information form the construction schedule and activity log to forecast and dispatch human and mechanical equipment needs to insure field activities and compliance is logged using mobile devices. The database stores GIS and GPS data along with AIM data or human generated field data, and calculated or generated AFM or reports. AIM data resulting from audits, engineered workmanship checklist, traveler form and test data sheets are calculated in the web server, systematically logged and retrievable through the use of GIS maps and viewed in 3D. The system provides real time AIM data thereby allowing the designers to modify their original designs based on actual field conditions. The server runs a preventative systematic checklist or traveler form to minimize the length of a punch list or a list of non-compliant items therefore facilitating the project commissioning. The checklist or traveler form is formatted on a mobile device to facilitate a rollup of field data and other sources of data occurring throughout the construction team, one or more site offices, and one or more project locations.

Advantages of the preferred embodiments may include one or more of the following. The final data can be computed and shared with all project team members using the WAN. The FCS is a systematic approach for insuring that the components in consideration complies with the contract document requirements and required signatures, inspections and standards. The dynamic traveler form allows for multiple projects, regardless of their stage in the life cycle process including but not limited planning, design, construction, operation, maintenance, inspection, testing laboratories and various processes and manufactured construction materials real time on the project cost, schedule, and quality assurance to be collected and assured of compliance. The status of a given project activity, including cost, schedule and quality can be determined in real time and be shared among all project team members. The system provides a complete view from all sources of data including AIM data collected by a human operator or laboratory, field and/or construction equipment. Such information links the entire management, engineer and construction team by use of a computer mobile or stationary that have been formatted with “raw” data sheets which have been designed to collect initial data that conforms to industry best practices such that contract compliance with required project standards is determined, management reports are readily available, dynamic reports can be viewed by the entire team in real time.

### BRIEF DESCRIPTION OF THE DRAWINGS

FIGS. 1A-1C show an exemplary process algorithm to provide program and/or portfolio facility control system for real time management of each components.

FIG. 2 shows an embodiment of a Traveler Form.

FIG. 3 shows an embodiment of a Traveler Form Example.

### DESCRIPTION

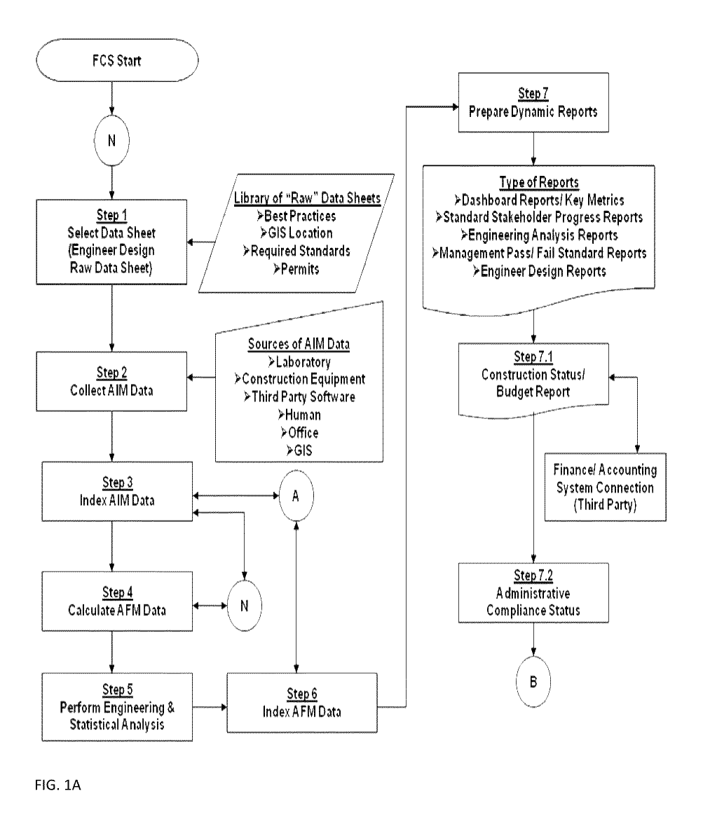

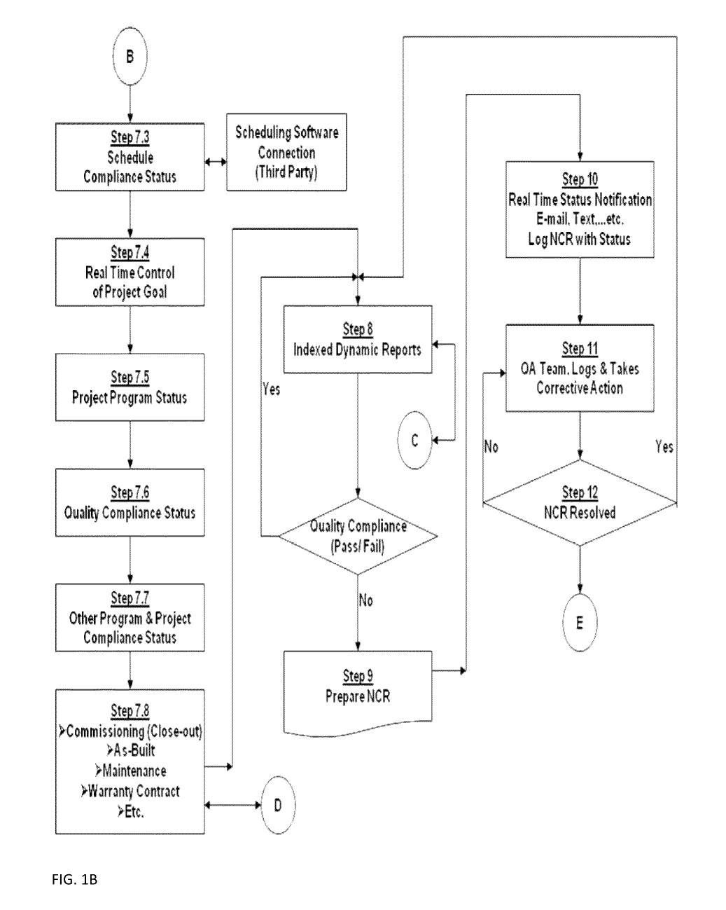

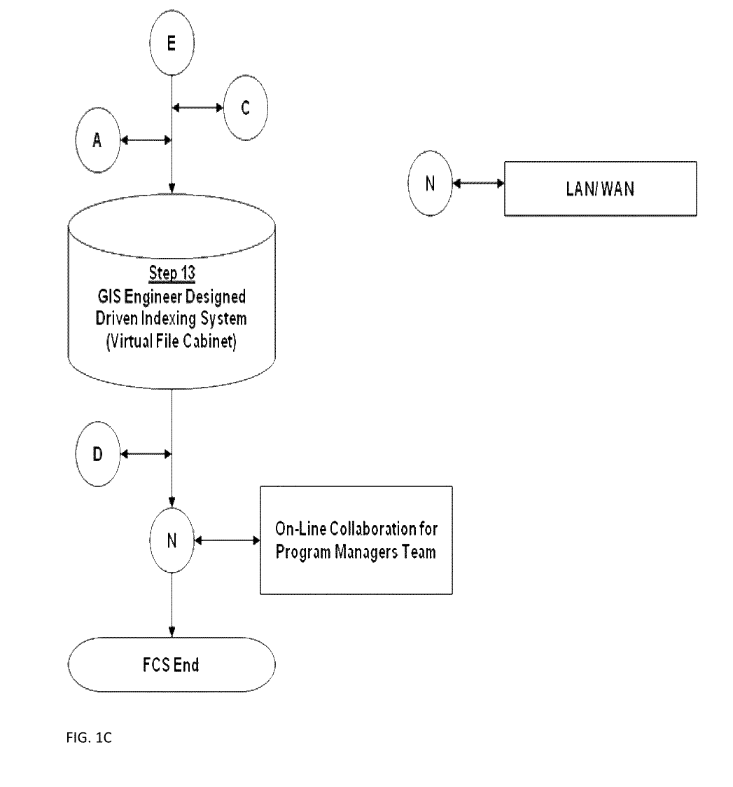

FIGS. 1A-1C show an exemplary process to provide construction management. From the start of the FCS process, the process selects data sheets such as engineering design raw data sheets, for example (step 1). For example, a library of raw data sheets can guide users as to best practices, GIS locations, required standards and permits, among others. Next, the process collects AIM data (step 2) from sources such as lab data, construction equipment, third party software, people, office data, or GIS systems, among others. The AIM data is indexed (step 3) and processed (step 4). Next, the process performs engineering and statistical analysis (step 5). The AFM data is indexed (step 6). Dynamic reports can be generated (step 7). The types of reports can include dashboard reports, metrics, progress reports, engineering analysis reports, and engineering design reports, among others.

The process can generate construction status or budget reports from finance/accounting systems or third party systems (step 7.1). The process can also check on administrative compliance status (step 7.2). The process can check on schedule compliance status (step 7.3) by connecting ton internal database or a third party scheduling software, for example. Next, the process can perform real time control of the project goal (step 7.4). Project program status can be determined (step 7.5). Quality compliance status can be checked (step 7.6). The process can also check other program/project compliance status (step 7.7). The project can also perform commissioning (close out) and check as built condition, maintenance and warranty contractual obligations, among others (step 7.8).

The process can index dynamically generated reports (step 8). Next, the process checks for quality compliance. The process prepares an NCR (step 9) and provides real time status notification through email, texting, among others (step 10) as well as logs the NCR with the status. Next, the process updates data for the QA team, the logs so that corrective action can be taken (step 11). The process checks if the NCR has been resolved (step 12) and once loops back to step 11 to resolve the problem and otherwise loops back to step 8.

FIG. 1C shows an exemplary database that receives data from connectors A, E, C of FIGS. 1A-1B and stores GIS engineer designed indexing system (step 13) which is the virtual file cabinet. The virtual cabinet can support connectors D and N for on-line collaboration of the teams, among others.

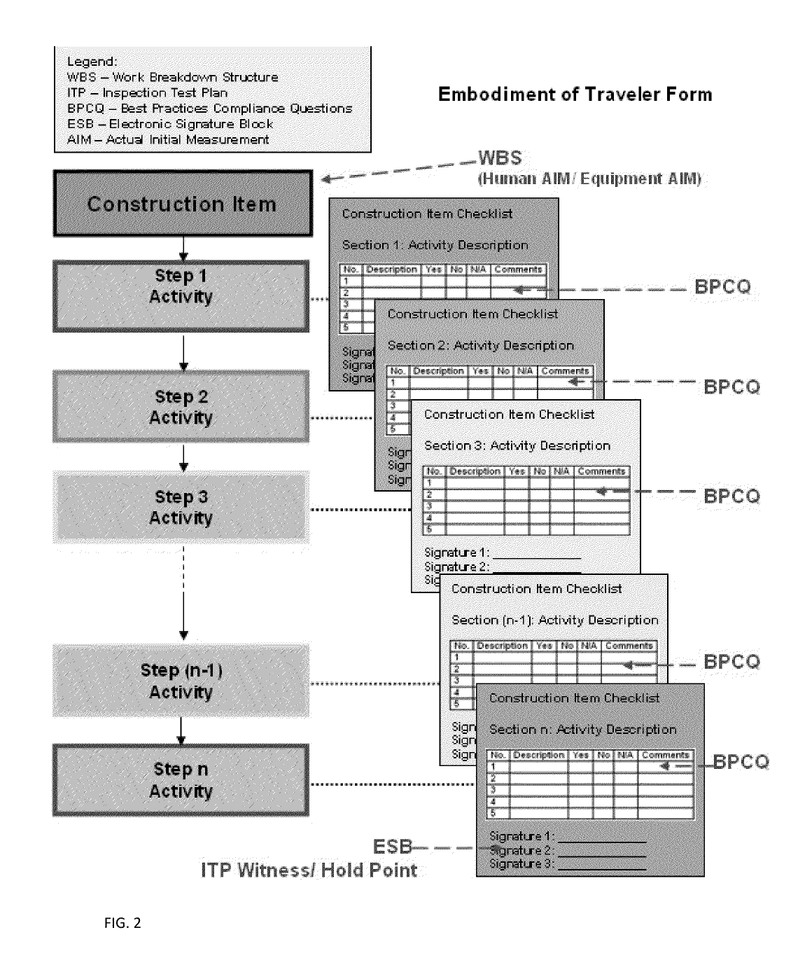

FIG. 2 illustrates the embodiment of traveler form. These forms are pre-engineered with best practices compliance questions (BPCQ) and are also designed to conform to WBS (work breakdown structure) or phases of work in accordance with the inspection test plan (ITP). The various activities are signed off electronically for each section of specific WBS item (i.e. section 1 through section n). Each section of form consists of various checklists can be signed off with the condition of hold point, witness point, surveillance or review by several field personnel. The entire construction of all items can be conformed to their phases of work with signoff to insure quality compliance.

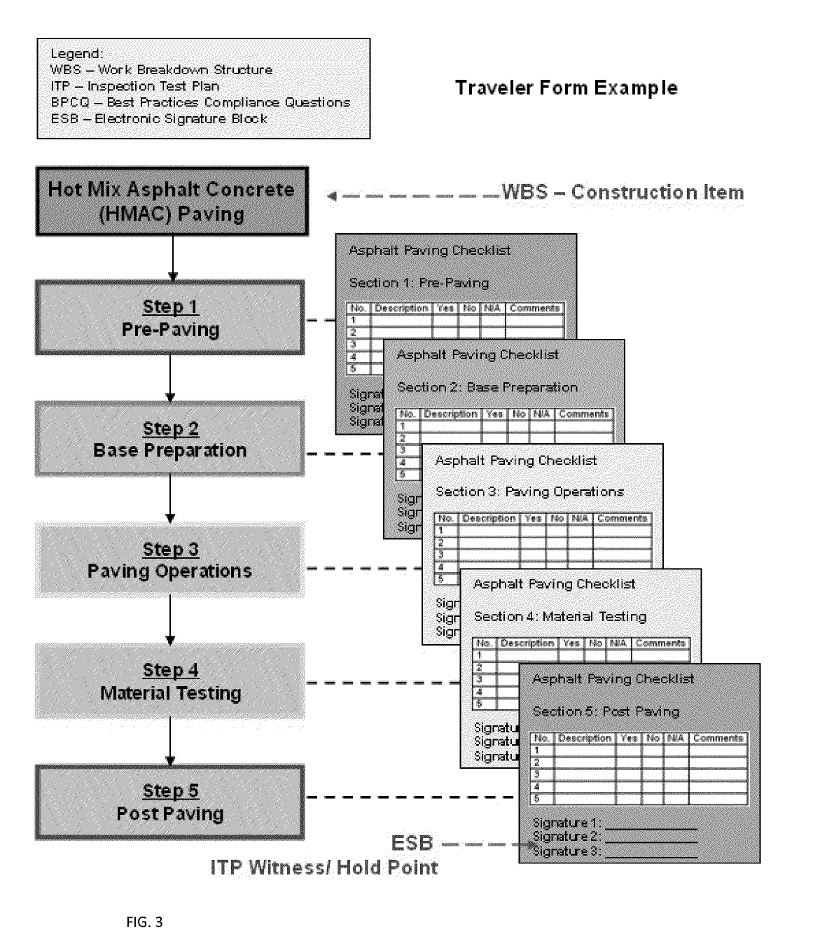

FIG. 3 shows an example of traveler form on hot mix asphalt concrete (HMAC) paving job. HMAC paving job is one of construction project phases in accordance with the WBS under project ITP in specific work, such as a HMAC overlay project. HMAC paving job can be separated into five (5) different sections (pre-paving, base preparation, paving operations, material testing and post paving) according to the sequence of the work. Every section has a series of BPCQ checklists to sign off by several field inspectors. Each checklist can be signed off with the condition of hold point, witness point, surveillance or review toward the next checklist. The checklist signed off with the hold point cannot proceed to the next checklist until the issue solved. The checklist signed off with the witness point, surveillance or review can be proceeding to the next checklist.

In one embodiment, the facility control system includes lab equipment with a wireless transceiver to transmit machine generated actual initial measurement (AIM) data from a field test to a wide area network; a mobile computer with a wireless transceiver to transmit human generated data from an office, a remote lab, or a field test to the network; and a server coupled to the network, the server including a database to receive machine and human generated AIM data, wherein the server applies statistics and engineering methods to predict specification compliance and performance, wherein the AIM data is used with pre-formatted engineered designed data sheets, including traveler form, that reflect the required standards and best practices including incorporating best construction practices for installation of one or more construction items and materials quality to promote standardization, uniformity that insures contract compliance and minimizes non-conforming items, wherein the AIM and actual final measurement (AFM) data is calculated on the server over the network in real time, wherein the server, lab equipment, and mobile computer form a systematic approach to provide real time dynamic reports regarding one or more components of a capital improvement program (CIP) or similar; wherein the systematic approach enables one or more construction teams to generate dynamic reports in real time that has been designed with best practices questions for each section that has been segmented according to its work breakdown structure. The dynamic report includes best practice questions within each work breakdown structure that insure compliance with contract requirements, and compliance with required signatures for inspection including hold, surveillance, review and other designed check points to minimize the event of non-compliant and disrupt the orderly progress of work. These traveler forms are dynamic and permit the work to segment in logical and sequential construction phases, whereas; each phase of work would be outfitted with best practice engineered designed data sheets, routed in accordance with required inspection and signature and that are visible throughout the entire process, for installation and testing of project activities and construction items, and wherein the systematic approach supports indexing of complete project specific data to facilitate document retrieval and project collaboration.

Advantages of the preferred embodiments may include one or more of the following. The final data can be computed and shared with all project team members using the WAN. The FCS is a systematic approach for insuring that the components in consideration complies with the contract document requirements and required signatures, inspections and standards. The dynamic traveler form allows for multiple projects, regardless of their stage in the life cycle process including but not limited planning, design, construction, operation, maintenance, inspection, testing laboratories and various processes and manufactured construction materials real time on the project cost, schedule, and quality assurance to be collected and assured of compliance. The status of a given project activity, including cost, schedule and quality can be determined in real time and be shared among all project team members. The system provides a complete view from all sources of data including AIM data collected by a human operator or laboratory, field and/or construction equipment. Such information links the entire management, engineer and construction team by use of a computer mobile or stationary that have been formatted with “raw” data sheets which have been designed to collect initial data that conforms to industry best practices such that contract compliance with required project standards is determined, management reports are readily available, dynamic reports can be viewed by the entire team in real time.

The system allows AIM and AFM to be calculated in a WAN in real time. The AIM data pre-formatted data sheets incorporate best engineering and construction practices for installation and materials quality to promote standardization, uniformity and insure contract compliance and minimize the occurrence of non-conforming items. In addition, the FCS approach implements a preventative systematic approach to minimize the effort in final project commissioning. Furthermore, the AIM checklist and traveler form can be are formatted on a mobile device or another other type of computer to facilitate the rollup of field data and all sources of data that occurring throughout the construction team various site office and other project locations.

The AIM engineered designed best practices standard forms are designed such that the data collected results in compliance with industry best practices and in addition to specification compliance. The use of “raw” pre-engineered best practice data sheets formatted for a human to enter data directly on a GIS map enables accurate 3D locations and associated data.

Potential Sources of AIM Data may include:

1. Data directly entered into a GIS map with pre-formatted data sheets

2. Data from Office Engineer/Project Manager desk top computer

3. Planning, Design and Construction managers and engineers, technicians and administrators use of a computer

4. Construction testers and inspectors use of computers with preformatted engineered designed “raw” data sheets, including traveler form, that encourage best practices in the industries such that “real time” status is determine, contract compliance, non-conformance items is also minimized

5. Laboratory equipment and construction field equipment are also a source of AIM data

6. Operations can also transfer AIM data directly into a WAN

7. Maintenance operations can also transfer AIM data directly into a WAN

8. Photographs, Video clips. Sketches of current site conditions

9. Data entered using a mobile field device

The AFM can be calculated according to industry standards and/or management preferences. The AFM dynamic reports have been validated, presented in best practices format and available in real time. The indexed AFM reports are dynamic and provide “true” real time status reports. The AFM reports can also be viewed in a GIS Map that permits the instant retrieval of “raw” AIM data. The Indexed AFM data provides a list of daily activities, dynamic reports, list of active NCR and initiates the NCR report process. The AFM data is used to determine compliance with project design, construction, operations and maintenance requirements, cost control, schedule control and regularity compliance. The data viewing rights are controlled in the system. The AFM are also presented on pre-design dynamic performance reports that allow trending and provide the manager the ability to avoid non-conformance and costly re-work. Alarming trends or non-conformance would be available to the management team in “true” real time. The results can be posted by the use of GIS map and facilitate data retrieval and analysis. In addition, since the AIM data is easily retrieved in the index system the resolution and management response and appropriate action is easily addressed. The data includes engineering data, photographs and video of actual conditions. Access to all data assist in providing a real time evaluation of the actual facility. The construction team has a dynamic environment that permits viewing of selected data and reports in “true” real-time. The current state of the art is linear viewing with many point to point interruptions (silos), rather than an integrated solution with real time information that has been designed to regulate inflow, outflow and final indexing. Pin point coordinates in 3D allow a unique view in graphical format.

The use of GIS pre-engineered best practiced “raw” data sheets allow the results to be viewed on a GIS map with exact coordinates pin-pointed from GPS. There the AIM and AFM data, reports are clearly identified by their respective locations with GPS assistance. The collection of AIM and AFM data can be viewed in 3D using the x, y, z coordinates. The collected data can be retrieved from a GIS map with specific spatial coordinates. The collected information can be retrieved and viewed from a GIS map with AIM and AFM information. This feature provides a unique efficient systematic approach to reviewing final data and its supporting documentation. This feature will also provide improved characterization of site conditions for future design and construction projects.

This invention introduces the use of a dynamic traveler form that first requires the inspection and testing planned requirements be identified, the work breakdown structure is then prepared and including a series of best practices checklists for each phase of the work breakdown structure with signature requirement in the facility control system. These forms are pre-engineered with best practices that have been designed to include best quality practices. The form is further designed to conform to WBS (work breakdown structure) or phases of work. The various activities signed off electronically in each phase of work. The entire construction of a specific item can be conformed to their phases of work with signoff to insure quality compliance. The traveler form can be access through the internet browser by use of a desktop or mobile device in true real time.

A checklist is a tool to help ensure the required work is performed, and performed in the most efficient sequenced and once completed meets contract requirements and intended quality. A checklist requires planning of required tasks, their sequencing and permits compliance verification during actual activity. This effort can be referred to as Specific Physical Task Sequencing (SPTS). Essentially a Task List, is generated which identifies items that must be performed and in their proper sequence. This effort is always prospective. It is prospective in that it is an implementation and consideration of the most efficient sequence of the required work.

In addition, the checklist provides “how to” implement the required work and facilitates the implementations using best practices. A Punch list is a list of items after construction that did not meet specifications or desired Quality. A punch list is a static document which is generally a list of tasks or “to-do” items that must be remedies before the project is accepted by the buyer. A punch list is retrospective in the sense it is a review of work already completed and note task remaining or deficiencies with work already completed.

Benefits of using the traveler form includes enabling a construction items to divide in phases of work in logical sequence with a series of question and/or parameters with associated hold point/witness point/surveillance/review for a greater certainty of compliance. This dynamic traveler form allows the construction item work flow, WBS in phases to make use of the hold point/witness point/surveillance/review during the construction process to require electronic sign off for quality compliance.

What is claimed is:

1. A facility control system, comprising:
lab and field equipment with a wireless transceiver to transmit machine generated actual initial measurement (AIM) data from a field activities, inspection and tests to a computer network, wherein the AIM data is accessible through a geographical information system (GIS);
a mobile computer with a wireless transceiver to transmit human generated data from an office, remote construction site, a remote lab, or an inspection or field test to the computer network, wherein the mobile computer logging the AIM data with GPS for 3D identification;
a server coupled to the network, the server including a central database to receive machine and human generated AIM data, wherein the server applies statistics and engineering methods to predict specification compliance and performance, wherein the AIM and AFM data is used with pre-formatted engineered designed data sheets and dynamic reporting that reflect the required standards and best practices including incorporating best construction practices for installation of one or more construction items and materials quality to promote standardization, uniformity that insures contract compliance and minimizes non-conforming items, wherein the AIM and AFM data is calculated on the server over the network in real time,
wherein the server, lab equipment, and mobile computer form a systematic approach to provide real time dynamic reports regarding one or more components of a capital improvement program (CIP); wherein the systematic approach enables one or more construction teams to generate dynamic reports in real time with best practice engineered designed data sheets for installation and testing of project activities and construction items, and wherein the systematic approach supports indexing of complete project specific data to facilitate document retrieval, project collaboration and the roll-up of the various projects in a program and or a portfolio.

2. The system of claim 1, wherein final data is calculated on the server and shared with project team members over the network.

3. The system of claim 1, wherein the server stores data in the central database for monitoring multiple projects or programs, regardless of their stage in the life cycle.

4. The system of claim 1, wherein the server stores data relating to planning, design, construction, operation, maintenance, inspection, testing laboratories and various processes and manufactured construction materials real time on the project cost, schedule, and quality assurance.

5. The system of claim 1, wherein a status of a given project activity quality can be determined in real time and be shared among all project team members.

6. The system of claim 1, comprising an integrated project management module coupled to a centralized database.

7. The system of claim 6, comprising:
a document control system;
an accounting system;
a scheduling system; and
a geographical information system (GIS).

8. The system of claim 6, comprising a planning module, a design module, a construction module, a maintenance module, and an operations module.

9. The system of claim 6, comprising an audit module, an estimating/scheduling module, an inspection module, and a testing module.

10. The system of claim 1, wherein the database captures actual final measurement (AFM).

11. The system of claim 1, wherein the statistics and engineering methods comprise aggregate, asphalt, concrete and soil tests and all types of construction materials.

12. The system of claim 1, comprising a plurality of pre-formatted forms stored in the mobile computer.

13. The system of claim 12, comprising a field engineering form to capture a cost, a schedule, labor, equipment and a quantity.

14. The system of claim 12, comprising an inspector form to capture a work activity, a daily report and a “checklist” designed with consideration of required standards, indexing logs and consideration of best practices installation report.

15. The system of claim 12, comprising a tester form to capture laboratory and field test data.

16. The system of claim one receive information form the construction schedule and activity log to forecast and dispatch human and mechanical equipment needs to insure field activities and compliance is logged using mobile devices.

17. The system of claim 1, wherein the database stores GIS and GPS data along with AIM data or human generated field data, and calculated or generated AFM or reports.

18. The system of claim 1, AIM data resulting from audits, engineered workmanship checklist, traveler form and test data sheets are calculated in the web server, systematically logged and retrievable through the use of GIS maps and viewed in 3D.

19. The system of claim 1, provides real time AIM data thereby allowing the designers to modify their original designs based on actual field conditions.

20. The system of claim 1, wherein the server runs a preventative systematic checklist or traveler form to minimize the length of a punch list or a list of non-compliant items therefore facilitating the project commissioning.

21. The system of claim 1, wherein the checklist or traveler form is formatted on a mobile device to facilitate a rollup of field data and other sources of data occurring throughout the construction team, one or more site offices, and one or more project locations.

22. The system of claim 1, wherein the server captures real time status of a specific contractor activity as well as a construction item utilizing in several construction contracts.
